(19) United States
(12) Patent Application Publication
(10) Pub. No.: US 2009/0056246 A1
(43) Pub. Date: Mar. 5, 2009

(54) IMPACT RESISTANT WINDOW ASSEMBLY AND METHOD

(75) Inventors: Ryan B. Prince, St. Paul, MN (US); Mario A. Perez, Burnsville, MN (US); Christopher A. Haak, Oakdale, MN (US); Howard S. Creel, Oakdale, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/846,056

(22) Filed: Aug. 28, 2007

(51) Int. Cl. E06B 5/10; E04G 21/24; E06B 3/56

(52) U.S. Cl. 52/204.53; 52/208; 52/746.1

(57) ABSTRACT

An impact-resistant window assembly includes a window frame, glazing having opposed major surfaces arranged within the window frame, window film arranged on at least one of the glazing opposed major surfaces, and sealant arranged to secure the window film to the window frame. Methods of making an impact-resistant window assembly and anchoring an applied window film to a window frame are also disclosed.

### BACKGROUND

The present invention relates generally to windows and, more particularly, to an impact resistant window assembly that utilizes window film applied to the window glass.

Window films are commonly applied to ordinary window glass, such as, for example, in existing windows in commercial buildings or residences, to enhance the impact resistance and other properties of the window. Such window films are available from 3M Company, St. Paul, Minn., under the trade designation 3M SCOTCHSHIELD Ultra Safety and Security window film. Such window films provide protection against, for example, natural events, such as hurricanes and earthquakes, and man made events such as explosions, and “smash-and-grab” burglaries. Such window films are adhesively bonded to the window glass, and the edge of the window film is secured to the window frame using a silicone sealant. The silicone sealant is applied along the edge of the window film and along the adjacent edge portion of the window frame.

In the event of an impact to the window glass, the window film holds the shattered glass in place. That is, the shattered shards of glass remain generally adhered to the window film after the impact. The silicone sealant, in turn, serves to hold the window film and the adhered shattered glass to the window frame. By retaining the shattered glass in the window opening, the window film reduces the potential for flying glass to cause injuries to occupants of the building, and also prevents wind and rain from entering and damaging the interior of the structure.

Impact resistant windows are known in the patented prior art. U.S. Pat. No. 6,101,783 (Howes), for example, discloses an impact resistant window including a frame holding a glass composite structure including first and second glass sheets secured to each other with a middle plastic layer.

The industry, however, is always seeking improved impact resistant window constructions, and improved methods of more securely attaching window film to a window frame.

### SUMMARY

There is a continuing need for improved impact resistant window constructions utilizing window film applied to the window glass that provide improved protection against impact, and which can be installed more quickly and easily. The present invention provides an improved impact resistant window film assembly that exhibits improved impact performance. The present invention also provides an impact resistant window assembly that includes a sealant that cures more quickly than currently available window film attachment sealants, thereby shortening the amount of time required to complete a job.

In one embodiment, the present invention provides an impact-resistant window assembly comprising a window frame, glazing having opposed major surfaces arranged within the window frame, window film arranged on at least one of the glazing opposed major surfaces, and sealant arranged to affix at least an edge of the window film to the window frame. In one aspect, the sealant has an adhesive strength, as measured according to ASTM C794-06, of at least about 250 pounds/square inch (psi) (1700 kilopascals (kPa)). In another aspect, the sealant has an adhesive strength, as measured according to ASTM C794-06, of at least about 300 psi (2100 kPa). In yet another aspect, when the sealant has cured for no greater than fourteen (14) days at 50% relative humidity and 75° F. (24° C.), the impact-resistant window assembly passes the Missile Level D test shown in Table 2 (Applicable Missiles) of ASTM E1996-06, and the pressure cycling test ASTM E1886-05 at a design pressure of 50 pounds per square foot (psf) (2.4 kPa). In yet another aspect, the sealant has a tensile strength, as measured according to ASTM D412-06A, of at least about 400 psi (2800 kPa), and has a cohesive strength, as measured according to ASTM D624-00E1, of at least 50 pounds per inch (lbs/in) (90 Newtons/centimeter (N/cm)). In another aspect, the sealant has an overlap shear strength of at least about 275 psi (1900 kPa).

In another embodiment, the sealant includes at least one of urethane, polyurethane, polyether, and polyurea. In a more specific embodiment, the sealant may comprise from about 40% by weight to about 60% by weight polyurethane, from about 10% by weight to about 30% by weight plasticizer, from about 25% by weight to about 45% by weight filler, and from about 1% by weight to about 5% by weight toluene. In other embodiments, the sealant may further comprise no greater than about 0.2% by weight phenyl isocyanate, and the filler may include clay and/or kaolin.

In another specific embodiment, the sealant may comprise from about 35% by weight to about 70% by weight filler, from about 15% by weight to about 40% by weight polyether, from about 10% by weight to about 30% by weight plasticizer, and from about 0.1% by weight to about 1% by weight (trimethoxysilylpropyl)ethylenediamine. In other embodiments, the sealant may further comprise no greater than about 2% by weight stearic acid, the filler may comprise calcium carbonate, and the plasticizer may comprise diisodecyl phthalate.

In another aspect, the present invention provides a method of constructing an impact-resistant window assembly that includes a window frame, glazing arranged in the window frame, and window film applied to a surface of the glazing. The method comprises the step of applying a sealant to the window film and to at least an adjacent portion of the window frame, thereby securing the window film to the window frame, wherein the sealant has an adhesive strength as measured according to ASTM C794-06 of at least about 250 psi (1700 kPa), and an adhesive strength greater than the cohesive strength (i.e. if the sealant fails, it experiences cohesive failure before it experiences adhesive failure).

In yet another aspect, the present invention provides a method of anchoring an applied window film to a window frame comprising the step of applying a sealant to the window film in the region adjacent the window frame and to at least an adjacent portion of the window frame, thereby securing the window film to the window frame to form an impact-resistant window assembly, wherein when the sealant has cured for no greater than fourteen (14) days at 50% relative humidity and 75° F. (24° C.), the impact-resistant window assembly passes the Missile level D test shown in Table 2 (Applicable Missiles) of ASTM E1996-06, and the pressure cycling test ASTM E1886-05 at a design pressure of 50 psf (2.4 kPa). In a more specific aspect, the sealant may have an adhesive strength, as measured according to ASTM C794-06, of at least about 250 psi (1700 kPa). In an even more specific aspect, the sealant has a tensile strength, as measured according to ASTM D412-06A, of at least about 400 psi (2800 kPa).

Advantages of certain embodiments of the invention include providing an impact resistant window assembly having improved impact resistance, providing a sealant that fully cures more quickly than previously known sealants and that has increased holding strength (i.e. forms a more secure attachment between the window film and the window frame), and providing a sealant that forms a secure attachment with a variety of window frame materials, including aluminum, without the need to prime the surface.

### BRIEF DESCRIPTION OF THE DRAWINGS

The present invention will be further described with reference to the accompanying drawings, in which:

FIG. 1 is a front plan view of an impact resistant window assembly according to the invention with a portion of the window film cut away to reveal the underlying glazing; and

FIG. 2 is a cross sectional view taken along line 2-2 of FIG. 1.

### DETAILED DESCRIPTION

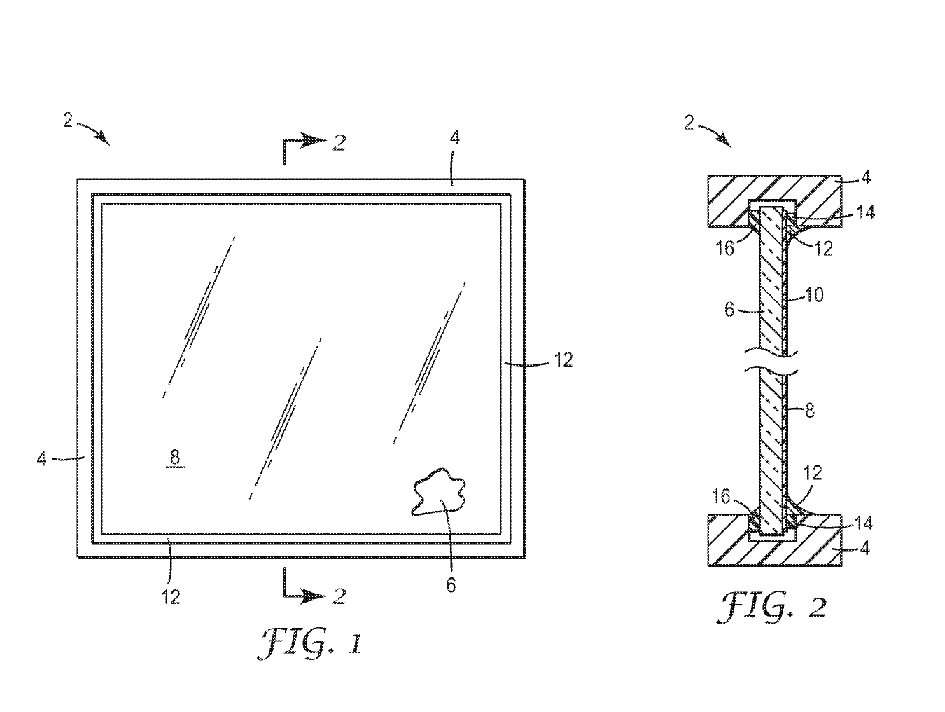

Referring now to the drawings, wherein like reference numerals refer to like or corresponding parts throughout, FIGS. 1 and 2 show an impact resistant window assembly 2 generally including a window frame 4, a pane of window glass or glazing 6 arranged within the window frame 4, window film 8 applied to the interior surface 10 of the glazing 6, and a sealant 12 applied along the adjacent edges of the window frame 4 and the window film 8. Interior and exterior gaskets 14, 16 (FIG. 2), respectively, are provided between the edges of the glazing 6 and the window frame 4 to create a tight seal with the glazing 6 and to secure the glazing 6 within the window frame 4.

The window frame 4 may be constructed from conventional materials such as wood, synthetic plastic materials, composites or metals, such as aluminum. In addition, such materials may be painted, for example, with acrylic, latex, or oil paint, or may include other coatings such as urethanes, epoxies, or lacquers. The glazing 6 is shown generically as a single pane of glass, but it may include insulated glass units, laminated glass, wire-glass, or other window glass constructions.

The particular window film 8 applied to the glazing 6 is not significant to the presently described invention, so long as it provides the desired level of impact resistance for the window assembly 2. Suitable window films include puncture and tear resistant films formed of, for example, one or more layers of a tough durable material, such as polyester. Suitable window films may optionally include an acrylic abrasion resistant coating, UV absorbers for blocking UV radiation, and/or coatings for reducing solar heat gain.

Suitable window films are described in, for example, U.S. Pat. No. 5,427,842 (Bland et. al.), U.S. Pat. No. 6,040,061 (Bland et. al.), and U.S. Pat. No. 4,540,623 (Im et. al.), the contents of which are hereby incorporated herein in their entirety. Suitable window films are commercially available from 3M Company, St. Paul, Minn. under the trade designation SCOTCHSHIELD Ultra Safety and Security Window Films. A specific SCOTCHSHIELD Ultra Safety and Security Window Film is the SH14CLARL window film. This window film may further be provided with solar control capability for reducing solar heat gain as indicated previously.

The window film 8 is adhesively bonded to the interior surface of the glazing 6 in a manner known to those skilled in the art. Because the window film 8 is adhesively bonded to the glazing 6, if the glazing 6 is broken, the shattered glass will remain generally adhered to the window film 8.

Sealant 12 is applied along at least a portion of the window film 8 near the perimeter of the window film 8 adjacent the window frame 4. The sealant 12 is applied so that it bonds to both the window film 8 and the window frame 4, thereby bonding the window film 8 to the window frame 4. Thus, in the event of an impact, the sealant 12 forms a strong bond that serves to anchor the window film 8 to the window frame 4 such that the window film 8, including the shattered window glass affixed to the window film 12, will remain in place in the window opening.

To form a suitably secure bond between the window frame 4 and the window film 8, it is desirable that the sealant 12 be capable of forming a secure bond with both the surface of the window frame 4 as well as the surface of the window film 8. In addition, the sealant 12 will have adequate cohesive strength to withstand the forces generally associated with the impacts for which it is designed. In addition to the final mechanical properties, it is desirable for the sealant 12 to have good application characteristics including easy dispensability, good workability, and adequate working time. It is also desirable for the sealant 12 to have the appropriate environmental durability including resistance to thermal and ultraviolet degradation, resistance to cleaning solvents and liquids, and resistance to plasticizers or other additives that may be present in the glazing gaskets or frame material. Other desirable properties of the cured sealant include appropriate aesthetic properties such as gloss, lack of chalking, and general appearance.

In addition to forming the desired bond with the respective surfaces of the window film 8 and the window frame 12, it is desirable that the sealant 12 cure quickly. That is, it is desirable that the sealant 12 quickly develops its ideal physical properties once it has been applied to a window assembly. It is also desirable that the sealant have high adhesive, cohesive, and tensile strength, and exhibit strong adhesion to a variety of materials including glass and metals, including untreated aluminum.

In accordance with one embodiment of the invention, the sealant 12 is substantially free of silicone. In one aspect, substantially free of silicone refers to the sealant having less than about 10%, less than about 5%, or less than about 1% silicone. In a further embodiment, the sealant 12 is free of silicone or includes only trace amounts of silicone. In another embodiment, the sealant 12 includes at least one of urethane, polyurethane, polyether, and polyurea.

In a more specific embodiment, the sealant composition comprises a mixture of polyurethane, plasticizer, filler, and toluene. The sealant may include at least about 20%, at least about 30%, or at least about 40% by weight polyurethane, and no greater than about 80%, no greater than about 70%, or no greater than about 60% by weight polyurethane.

The sealant may include at least about 1%, at least about 5%, or at least about 10% by weight plasticizer, and no greater than about 50%, no greater than about 40%, or no greater than about 30% by weight plasticizer.

The sealant may include at least about 5%, at least about 15%, or at least about 25% by weight filler, and no greater than about 65%, no greater than about 55%, or no greater than about 45% by weight filler. The filler may include clay, such as kaolin. In addition, if the sealant is to be colored, the filler may include, for example, carbon black or titanium dioxide.

The sealant mat include at least about 0.01%, at least about 0.5%, or at least about 1% by weight toluene, and no greater than about 10%, no greater than about 7%, or no greater than about 5% by weight toluene.

The sealant may further comprise no greater than about 2%, no greater than about 1%, or no greater than about 0.2% by weight phenyl isocyanate.

In another embodiment, the sealant composition comprises a mixture of filler material, polyether, plasticizer, and (trimethoxysilylpropyl)ethylenediamine. The sealant may include at least about 15%, at least about 25%, or at least about 35% by weight filler, and no greater than about 90%, no greater than about 80%, or no greater than about 70% by weight filler. The filler may comprise calcium carbonate. In addition, if the sealant is to be colored, the filler may include, for example, carbon black or titanium dioxide.

The sealant may include at least about 5%, at least about 10%, or at least about 15% by weight polyether, and no greater than about 60%, no greater than about 50%, or no greater than about 40% by weight polyether.

The sealant may include at least about 1%, at least about 5%, or at least about 10% by weight plasticizer, and no greater than about 50%, no greater than about 40%, or no greater than about 30% by weight plasticizer. An example of a suitable plasticizer is diisodecyl phthalate.

The sealant may include at least about 0.01%, at least about 0.05%, or at least about 0.1% by weight (trimethoxysilylpropyl)ethylenediamine, and no greater than about 3%, no greater than about 2%, or no greater than about 1% by weight (trimethoxysilylpropyl)ethylenediamine.

The sealant may further comprise no greater than about 5%, no greater than about 3%, or no greater than about 2% by weight stearic acid.

Suitable sealants are commercially available from 3M Company, St. Paul, Minn. under the trade designations 3M Auto Glass Urethane Windshield Adhesive—Medium Viscosity (Part No. 08693, 3M# 60-9800-2405-7) and 3M Marine Adhesive Sealant Fast Cure 4000 UV (Part No. 06580, 3M#60-9800-4288-5).

To secure the window film 8 to the window frame 4, a bead of sealant 12 is applied to the edge of the window film 8 and to the adjacent portion of the window frame 4. The sealant 12 is applied in such a manner that—after curing for no greater than about fourteen (14) days, or no greater than about seven (7), or even no greater than about three (3) days at 50% relative humidity and 75° F. (24° C.)—the impact-resistant window assembly 2 passes the Missile Level D test shown in Table 2 (Applicable Missiles) of ASTM E1996-06, as well as pressure cycling test ASTM E1886-05 at a design pressure of 50 psf (2.4 kPa). In one aspect, the sealant is applied along the entire perimeter of the window film and to the adjacent window frame such that the sealant overlaps approximately ⅜ of an inch (1 cm) on both the window film and to the window frame, and is allowed to cure at ambient conditions for 14 days.

The sealant 12 typically substantially fully cures in less than about fourteen (14) days, less than about seven (7) days, or even in less than about three (3) days at 50% relative humidity and 75° F. (24° C.). In one aspect, substantially fully cured refers to the sealant having developed at least about 75% of its full adhesive strength, at least about 85% of its full adhesive strength, or at least about 95% of its full adhesive strength. When the sealant is substantially fully cured, it is generally non-tacky and can no longer be easily worked.

In another aspect, substantially fully cured refers to the condition of the sealant after it has cured sufficiently to allow a window assembly 2 having an appropriate bead of sealant applied to the window film 8 and to the adjacent portion of the window frame 4 to pass the Missile Level D test shown in Table 2 (Applicable Missiles) of ASTM E1996-06, as well as pressure cycling test ASTM E1886-05 at a design pressure of 50 psf (2.4 kPa). In yet another aspect, substantially fully cured refers to the condition of the sealant after it as been allowed to cure for fourteen (14) days at 50% relative humidity and 75° F. (24° C.).

In one embodiment, the fully cured sealant 12 may have a tensile strength, as measured according to ASTM D412-06A, of at least about 400 psi (2800 kPa), at least about 600 psi (4100 kPa), or even at least about 1000 psi (6900 kPa), and no greater than about 2000 psi (14,000 kPa), no greater than about 1700 psi (12,000 kPa), or even no greater than about 1400 psi (10,000 kPa). The tensile strength of the fully cured sealant is also referred to as the “ultimate” tensile strength of the sealant. A substantially fully cured sealant also refers to a sealant that has developed at least about 90% of its ultimate tensile strength, or at least about 95% of its ultimate tensile strength.

The substantially fully cured sealant 12 generally has adhesive strength greater than its cohesive strength. As such, if the sealant fails, it generally remains adhered to the respective surfaces of the window and window film and separates internally. In one embodiment, the sealant has a cohesive strength, as measured according to ASTM D624-00E1, of at least 50 lbs/in (90 N/cm), at least about 60 lbs/in (105 N/cm), or even at least about 70 lbs/in (120 N/cm).

The substantially fully cured sealant 12 may have an adhesive strength, as measured according to ASTM C794-06, of at least about 250 psi (1700 kPa), at least about 300 psi (2100 kPa), or even at least about 350 psi (2400 kPa).

The substantially fully cured sealant 12 may also have an overlap shear strength, as measured according to the test set forth in the Examples below, of at least about 275 psi (1900 kPa), at least about 300 psi (2070 kPa), or at least about 325 psi (2240 kPa).

Other desirable properties of the sealant include UV resistance, low odor, low or non-shrinking, non-corrosive, non-cracking, paintable, and useful over a wide range of temperatures.

In another aspect, the invention provides a method of anchoring a window film 8 applied to the surface of a pane of glazing 6 to a window frame 4 by applying any one of the sealants described above to at least a portion of the window film in a region adjacent a window frame, and to at least an adjacent portion of the window frame, thereby securing the window film to the window frame.

The invention also provides a method of rendering an existing window construction impact resistant by applying a window film to the glazing and then applying any one of the sealants described above to at least a portion of the window film in a region adjacent a window frame, and to at least an adjacent portion of the window frame, thereby securing the window film to the window frame.

The invention also provides a method of making an impact-resistant window assembly including a window frame, glazing arranged in the window frame, and window film applied to a surface of the glazing. The method comprises applying any one of the sealants described above to least a portion of the window film in a region adjacent a window frame, and to at least an adjacent portion of the window frame, thereby securing the window film to the window frame.

The invention may be used in impact resistant window systems for new construction or for retrofit systems for existing homes or buildings. That is, the invention may be used in the manufacturing of new, yet to be installed, windows, or it may be used to impart improved impact resistance to existing window constructions. It will be recognized that the term windows should be understood to include skylights or other structures that include glass.

In order that the invention described herein can be more fully understood, the following examples are set forth. It should be understood that these examples are for illustrative purposes only, and are not to be construed as limiting this invention in any manner.

### EXAMPLES

### Overlap Shear Strength

Overlap shear (OLS) strengths were measured on 2.5 cm (1 inch) wide by 2.5 cm (1 inch) overlap specimens. These bonds were made individually using 2.5 cm (1 inch)×10 cm (4 inch) sample coupons made from bare aluminum. The thickness of the bond line was controlled with 1.8-3.6 mm (0.07-0.14 inch) stainless steel wires. The thickness of the aluminum substrates was 8.9 mm (0.035 inch). All strengths were measured at 23° C. The separation rate of the testing jaws was 51 cm (20 inches) per minute.

All bonds were cured for a minimum period of 21 days at 25° C./50% RH before testing. Bonds were prepared by cleaning the surface with 2-propanol and allowing the solvent to completely evaporate. In all cases, cohesive failure of the sealant was observed.

### Large Missile Impact Test

A test surface which consisted of tempered glass with 3M SCLARL (SH14) safety film applied thereto was impacted with a large missile. The sealants used in the Examples were utilized to secure the film to a painted aluminum frame. The protective film was applied to the side of the glass that was not impacted. The thickness of this protective layer was 0.89 millimeters (mm) to avoid puncture and facilitate stress transfer to the attaching sealant of interest. This protective layer was cut to be flush to the frame.

The sealant was then applied as a triangular cross-section bead. The sealant overlapped 9.5 mm of the film and 6.4 mm in the thinnest part of the frame (top and bottom members). The sealants were applied after degreasing the painted frame with acetone. The test set-ups were set aside for a month before testing.

The missile was a 4.1 kg piece of lumber with nominal dimensions of 5.1×10.2×244 cm. The missile was launched at a speed of 15.2 meters per second. The tests were conducted at HETI (Hurricane Engineering and Testing, Inc.) where a Miami-Dade building code protocol is followed. The glass surface was impacted first at the center and then at a corner. The strike site is approximately 38 to 45 centimeters from the frame for the center impact, and 15 cm from each side on the corner. The results of the test are set forth in the tables below.

### COMPARATIVE EXAMPLE

### Silicone Sealant

| Sealant | Overlap Shear Strength (kPa) |
|---|---|
| Silicone Sealant | 1580 ± 220 (229 ± 32 psi) |

| | | Speed | | |
|---|---|---|---|---|
| Sealant | Impact | (m/sec) | Pass/Fail | Comments |
| Silicone Sealant | center | 15 | Pass | No sealant breach |
| Silicone Sealant | corner | 15 | Failed | Cohesive failure |

### Example 1

### Polyether Sealant

| Sealant | Overlap Shear Strength (kPa) |
|---|---|
| Polyether Sealant | 2630 ± 100 (382 ± 15 psi) |

| | | Speed | | |
|---|---|---|---|---|
| Sealant | Impact | (m/sec) | Pass/Fail | Comments |
| Polyether Sealant | center | 14.9 | Pass | No sealant breach |
| Polyether Sealant | corner | 15 | Pass | No sealant breach |

The sealant used in the Comparative Example was a silicone based sealant such as Dow Coming 995 Silicone Structural Sealant. The sealant used in Example 1 was a polyether based sealant such as 3M Marine Adhesive Sealant Fast Cure 4000 UV.

Persons of ordinary skill in the art may appreciate that various changes and modifications may be made to the invention described above without deviating from the inventive concept. Thus, the scope of the present invention should not be limited to the structures described in this application, but only by the structures described by the language of the claims and the equivalents of those structures.

What is claimed is:

1. An impact-resistant window assembly, comprising:
(a) a window frame;
(b) glazing having opposed major surfaces arranged within the window frame;
(c) window film arranged on at least one of the glazing opposed major surfaces; and
(d) sealant having an adhesive strength as measured according to ASTM C794-06 of at least about 250 psi arranged to affix at least an edge of the window film to the window frame.

2. An impact-resistant window assembly as defined in claim 1, wherein the sealant has an adhesive strength as measured according to ASTM C794-06 of at least about 300 psi.

3. An impact-resistant window assembly as defined in claim 2, wherein when the sealant has cured for no greater than fourteen (14) days at 50% relative humidity and 75° F., the impact-resistant window assembly passes the Missile Level D test shown in Table 2 (Applicable Missiles) of ASTM E1996-06, and the pressure cycling test ASTM E1886-05 at a design pressure of 50 psf.

4. An impact-resistant window assembly as defined in claim 3, wherein the sealant has a tensile strength as measured according to ASTM D412-06A of at least about 400 psi, and has a cohesive strength as measured according to ASTM D624-00E1 of at least 50 lbs/in.

5. An impact-resistant window assembly as defined in claim 4, wherein the sealant includes at least one of urethane, polyurethane, polyether, and polyurea.

6. An impact-resistant window assembly as defined in claim 1, wherein the sealant comprises:
(a) from about 40% by weight to about 60% by weight polyurethane;
(b) from about 10% by weight to about 30% by weight plasticizer;
(c) from about 25% by weight to about 45% by weight filler; and
(d) from about 1% by weight to about 5% by weight toluene.

7. An impact-resistant window assembly as defined in claim 6, wherein the sealant further comprises no greater than about 0.2% by weight phenyl isocyanate.

8. An impact-resistant window assembly as defined in claim 7, wherein the filler includes clay.

9. An impact-resistant window assembly as defined in claim 8, wherein the filler comprises kaolin.

10. An impact-resistant window assembly as defined in claim 1, wherein the sealant comprises:
(a) from about 35% by weight to about 70% by weight filler;
(b) from about 15% by weight to about 40% by weight polyether;
(c) from about 10% by weight to about 30% by weight plasticizer; and
(d) from about 0.1% by weight to about 1% by weight (trimethoxysilylpropyl)ethylenediamine.

11. An impact-resistant window assembly as defined in claim 10, wherein the sealant further comprises no greater than about 2% by weight stearic acid.

12. An impact-resistant window assembly as defined in claim 11, wherein the filler comprises calcium carbonate.

13. An impact-resistant window assembly as defined in claim 12, wherein the plasticizer comprises diisodecyl phthalate.

14. A method of making an impact-resistant window assembly including a window frame, glazing arranged in the window frame, and window film applied to a surface of the glazing, the method comprising applying a sealant to the window film and to at least an adjacent portion of the window frame, thereby securing the window film to the window frame, wherein the sealant has an adhesive strength as measured according to ASTM C794-06 of at least about 250 psi, and an adhesive strength greater than the cohesive strength.

15. A method of making an impact-resistant window assembly as defined in claim 14, wherein the sealant comprises:
(a) from about 40% by weight to about 60% by weight polyurethane;
(b) from about 10% by weight to about 30% by weight plasticizer;
(c) from about 25% by weight to about 45% by weight filler; and
(d) from about 1% by weight to about 5% by weight toluene.

16. A method of making an impact-resistant window assembly as defined in claim 14, wherein the sealant comprises:
(a) from about 35% by weight to about 70% by weight filler;
(b) from about 15% by weight to about 40% by weight polyether;
(c) from about 10% by weight to about 30% by weight plasticizer; and
(d) from about 0.1% by weight to about 1% by weight (trimethoxysilylpropyl)ethylenediamine.

17. A method of anchoring an applied window film to a window frame, comprising applying a sealant to the window film in the region adjacent the window frame and to at least an adjacent portion of the window frame, thereby securing the window film to the window frame to form an impact-resistant window assembly, wherein when the sealant has cured for no greater than fourteen (14) days at 50% relative humidity and 75° F., the impact-resistant window assembly passes the Missile Level D test shown in Table 2 (Applicable Missiles) of ASTM E1996-06, and the pressure cycling test ASTM E1886-05 at a design pressure of 50 psf.

18. A method as defined in claim 17, wherein the sealant has an adhesive strength as measured according to ASTM C794-06 of at least about 250 psi.

19. A method as defined in claim 17, wherein the sealant has a tensile strength as measured according to ASTM D412-06A of at least about 400 psi.

20. A method as defined in claim 17, wherein the sealant has an overlap shear strength as measured according the test procedure set forth in the Examples of at least about 275 psi.
